(19) United States
(12) Patent Application Publication
(10) Pub. No.: US 2022/0064033 A1
(43) Pub. Date: Mar. 3, 2022

(54) Fluoride delivery device for water system

(71) Applicant: K.C. Industries, LLC, Mulberry, FL (US)

(72) Inventor: Steven McCarter, Mulberry, FL (US)

(21) Appl. No.: 17/007,176

(22) Filed: Aug. 31, 2020

(51) Int. Cl. C02F 1/68; B01F 1/00; B01F 5/00; B01F 13/10; B01F 15/00

(52) U.S. Cl. CPC C02F 1/688; B01F 1/0027; B01F 1/0038; B01F 5/0071; B01F 2215/0052; B01F 15/00136; B01F 2001/0061; B01F 2005/0005; B01F 2005/0037; B01F 13/1013

(57) ABSTRACT

The fluoride tablet feeder device is a device for dissolution of fluoride tablets into a water stream. The device is specifically designed for the fluoride tablets disclosed and claimed by U.S. Pat. No. 10,485,738 titled Tablet for Fluoridating Potable Water, which is incorporated by reference. The crux of ideal dissolution of fluoride tablets in a flowing water supply is total immersion of the tablets, with water flowing around all tablet sides for even dissolution.

### FIELD

This invention relates to the field of water fluoridation and more particularly to a device that adds fluoride to water, the water used in a municipal water system.

### BACKGROUND

The prevention of tooth decay is an important matter of public policy. Treatment of teeth with fluoride helps to reduce tooth decay. But to be effective, broad distribution is required.

Fluoride treatment of public drinking water is a cost-effective means of delivering fluoride to nearly every citizen. The result is a reduction in public health costs associated with tooth decay.

But municipalities are cost-sensitive and overworked. What is needed is a device for simple addition of fluoride to a water supply, the device requiring minimal attention and intervention.

### SUMMARY

The fluoride tablet feeder device is a device for dissolution of fluoride tablets into a water stream. The device is specifically designed for the fluoride tablets disclosed and claimed by U.S. Pat. No. 10,485,738 titled Tablet for Fluoridating Potable Water, which is incorporated by reference. But other tablets may be used.

The crux of ideal dissolution of fluoride tablets in a flowing water supply is total immersion of the tablets, with water flowing around all tablet sides for even dissolution.

The device accomplishes this dissolution by holding the tablets within a column, and running water from bottom to top, passing the flowing water around the tablets.

By flowing water from the bottom to the top, the water column remains full of water regardless of flow rate, thus passing water around all tablets.

In the opposite orientation—the inlet at the top and the outlet at the bottom—a low input flow rate could allow gravity to force water to drain out of the column through the outlet, resulting in only partially submerged tablets. The result would be that new incoming water, entering the top, would fall through a portion of the tablets with only partial contact and reach the outlet without incomplete fluoridation.

The disclosed embodiment uses three columns, but the use of a greater or lesser number of columns is anticipated. The use of two or more columns allows for adjustment over a wide range of flow rates by opening and closing branches, as well one or more column to be removed from service for refilling.

Each column is sized to hold up to 250 tablets. Assuming the device is set up with three columns, it can handle treatment of up to 350,000 gallons per day.

The columns are largely hollow, with an internal space for a multiplicity of fluoride tablets.

Flow through the device is as follows: raw, or untreated water enters at the inlet. The water passes into one or more of the branches, depending on which isolation valves are open. The water then passes through a flow meter, each branch having its own flow meter. Water then enters the bottom of a column, passing through a screen, the screen preventing pieces or fragments of tablets from passing into the intake piping.

The water then moves upward through the column, passing around the fluoride tablets as it moves up.

By flowing water upward, all tablets must be immersed before any water reaches the overflow. Thus, full fluoridation is always reached before water is permitted to exit the column.

After the tube/column fills with water, and has flowed over the tablets, the fluoride-treated water passes through a second screen and into the top of the outlet riser.

The water then passes out of the tube, through a check valve, and to a single main outlet. A secondary outlet with valve and barbed fitting is present, ideally for taking samples.

The device is preferably mounted on top of a 40″×48″ pallet with solid bottom. The pallet format makes the system easy to use, and the solid bottom contains any leaks.

The fluoride tablet feeder device is intended for use with tablets formed from sodium fluorosilicate, a binder; and a punch release agent. A punch release aid allows tablets to be ejected from the tablet press more easily, minimizing breaking or shearing of the tablets. Preferred punch release agents include magnesium stearate, calcium stearate, hydrogenated vegetable oil, hydrogenated cottonseed oil, starch, hydroxypropyl cellulose, and sodium alkylnaphthalenesulfonate.

A binder helps to hold the table together. Preferred binders include hydroxypropylcellulose, hydrogenated cottonseed oil, magnesium tearate, calcium tearate, starch, hydroxypropyl cellulose, and sodium alkylnaphthalenesulfonate.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first view of the fluoride tablet feeder device.

FIG. 2 illustrates a second view of the fluoride tablet feeder device.

FIG. 3 illustrates a third view, showing a partial fill of tablets and water, of the fluoride tablet feeder device.

FIG. 4 illustrates a fourth view, showing a complete fill of tablets and water, of the fluoride tablet feeder device.

FIG. 5 illustrates a fifth view, showing the water overflow, of the fluoride tablet feeder device.

FIG. 6 illustrates an overhead schematic view of the fluoride tablet feeder device.

FIG. 7 illustrates a side schematic view of the fluoride tablet feeder device.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

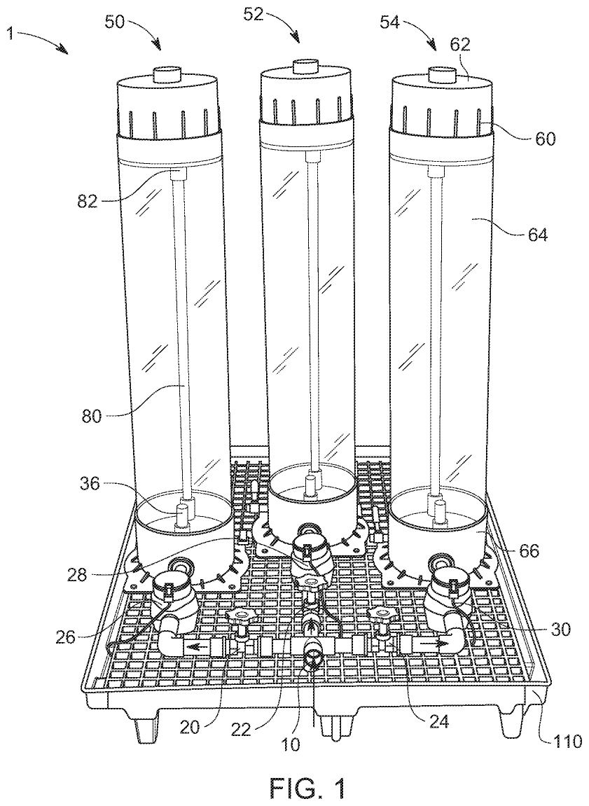

Referring to FIG. 1, a first view of the fluoride tablet feeder device is shown.

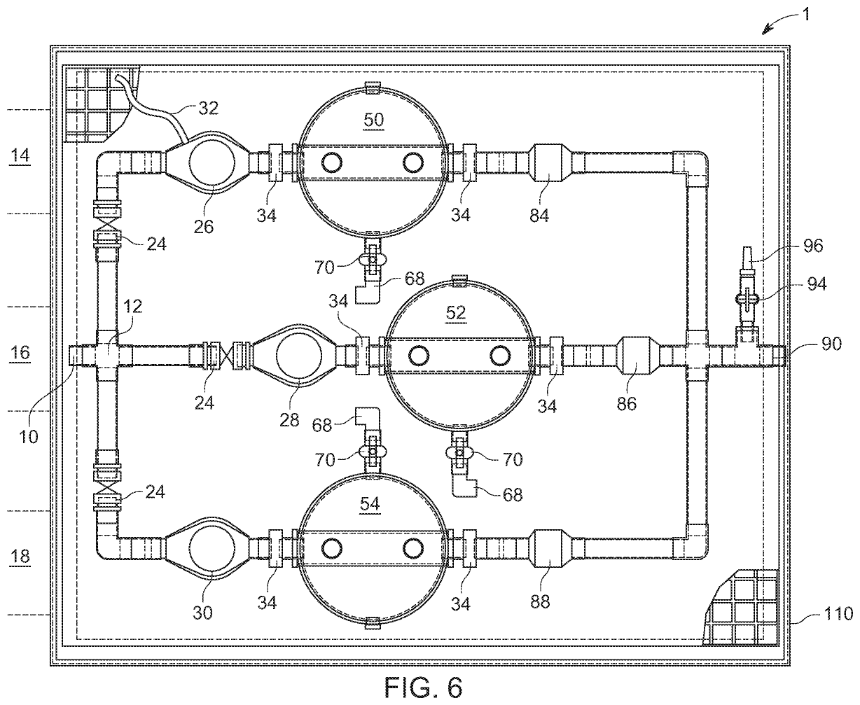

The fluoride tablet feeder device 1 is shown with the primary inlet 10, leading to cross fitting 12, separating the flow into branch one 14, branch two 16, and branch three 18 (see FIG. 6 for branch labels). Each branch 14/16/18 includes a valve, specifically isolation valve one 20, isolation valve two 22, isolation valve three 24. The flow of water passes through the relevant flow meter, including flow meter one 26, flow meter two 28, and/or flow meter three 30. Each flow meter 26/28/30 includes a flow meter sensor line 32 (see FIG. 6), carrying its flow data back to a computer for collection.

The water then flows into tablet column one 50, tablet column two 52, and/or tablet column three 54. Water enters through the inlet screen 36, exiting through the outlet screen 82 and passing down the outlet riser 80.

Each tablet column 50/52/54 is formed from a top 60, cap 62, sleeve 64, and base 66.

The fluoride tablet feeder device 1 is mounted on pallet 110, which simplifies transport and installation of the device, as well as containing spills.

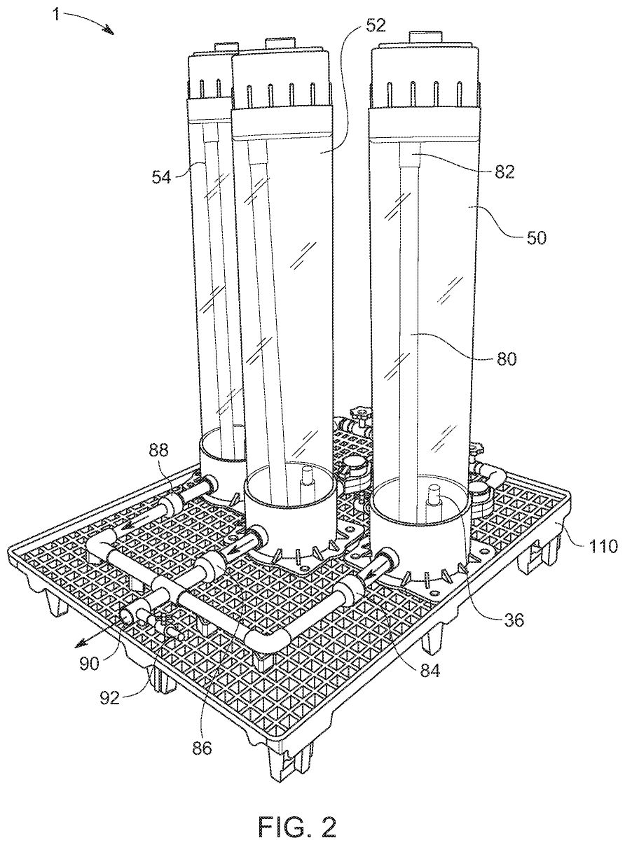

Referring to FIG. 2, a second view of the fluoride tablet feeder device is shown.

After entering a tablet column 50/52/54 through an inlet screen 36, the water exits through the outlet screen 82 and passes down the outlet riser 80. Water continues through a check valve, including check valve one 84, check valve two 86, and/or check valve three 88, exiting the fluoride tablet feeder device 1 at the primary outlet 90.

Also shown is secondary outlet 92 with valve 94 and barbed fitting 96 for sampling.

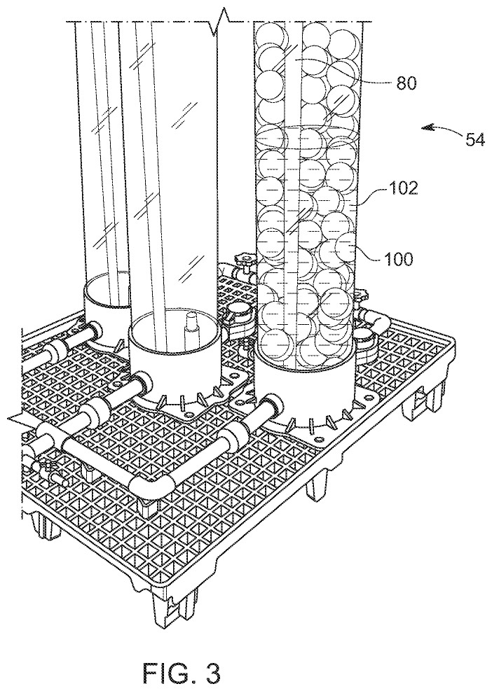

Referring to FIG. 3, a third view, showing a partial fill of tablets and water, of the fluoride tablet feeder device is shown.

The tablet column three 54 is shown filled with tablets 100 and partially filled with water 102. The water 102 has not reached the top of the outlet riser 80, and thus cannot yet exit the tablet column three 54.

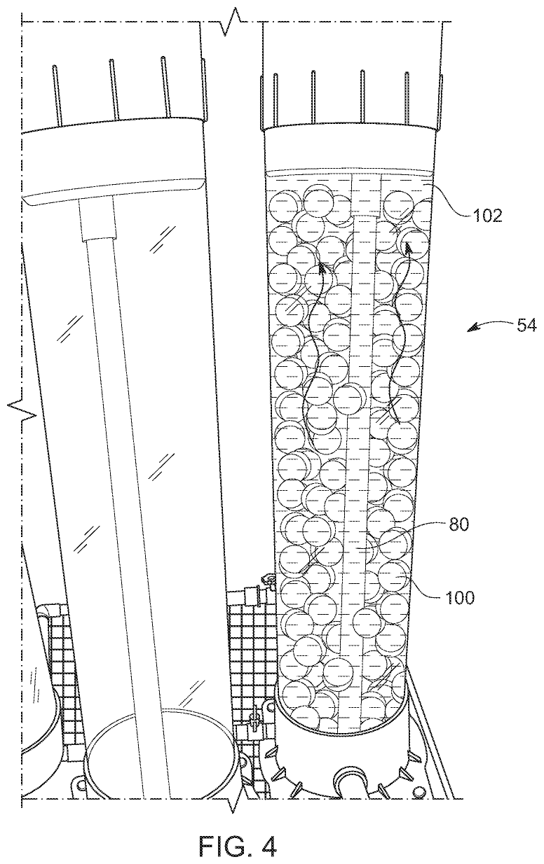

Referring to FIG. 4, a fourth view, showing a complete fill of tablets and water, of the fluoride tablet feeder device is shown.

Again shown is tablet column three 54, but with a full quantity of both tablets 100 and water 102. Water 102 is shown flowing upward, and passing into the outlet riser 80.

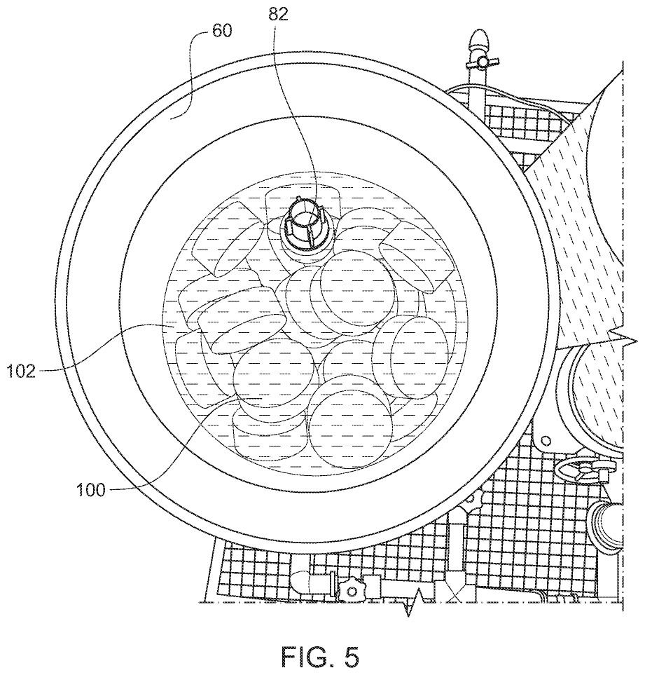

Referring to FIG. 5, a fifth view, showing the water overflow, of the fluoride tablet feeder device is shown.

The water 102 has reached the outlet screen 82, fully covering the tablets 100.

The top 60 is shown with cap 62 (see FIG. 1) removed.

Referring to FIG. 6, an overhead schematic view of the fluoride tablet feeder device is shown.

The fluoride tablet feeder device 1 starts with primary inlet 10, leading to the cross fitting 12 breaking the paths into branch one 14, branch two 16, and branch three 18.

Isolation valve one 20, isolation valve two 22, and isolation valve three 24 control the flow path, leading to flow meter one 26, flow meter two 28, and flow meter three 30, each with a flow meter sensor line 32.

Threaded unions 34 allow for removal of tablet column one 50, tablet column two 52, and tablet column three 54 for maintenance.

Each tablet column 50/52/54 includes a drain line 68 with drain valve 70.

Flow continues to check valve one 84, check valve two 86, and check valve three 88, eventually reaching the primary outlet 90.

Also shown is secondary outlet 92 with valve 94 and barbed fitting 96.

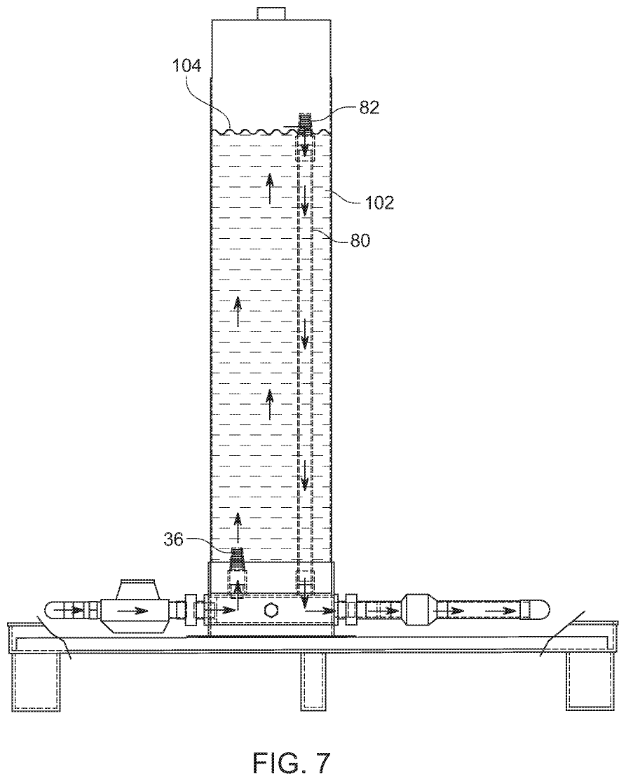

Referring to FIG. 7, a side schematic view of the fluoride tablet feeder device is shown.

The flow of water 102 is shown from inlet screen 36, up to the overflow water level 104, then into the outlet screen 82 and down the outlet riser 80.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A device for dissolution of fluoride tablets into water, the device comprising:
a column to hold the fluoride tablets;
a water inlet at a base of the column;
a water outlet at a top of the column;
the water flowing into the column at the water inlet, flowing up the column and through the fluoride tablets, the water exiting the column at the water outlet;
whereby water flows from the base of the column upward to ensure that water must flow from the water inlet to the water outlet.

2. The device of claim 1, wherein the water only exits the column when the water has risen to an overflow water level that is even with the water outlet at the top of the column.

3. The device of claim 2, further comprising:
an inlet screen at the water inlet, preventing fragments of the fluoride tablets from passing into the water inlet; and
an outlet screen at the water outlet, preventing fragments of the fluoride tablets from passing into the water outlet.

4. The device of claim 1, wherein the fluoride tablets comprise:
sodium fluorosilicate;
a binder; and
a punch release aid.

5. The device of claim 1, further comprising:
an isolation valve upstream of the column;
a flow meter upstream of the column;
a check valve downstream of the column;
whereby the isolation valve is used to start and stop the water from reaching the column from the water inlet, and the check valve prevents water from flowing into the water outlet, thus allowing for refilling of the fluoride tablets; and
whereby the flow meter meters the water, thus allowing for measurement of the water.

6. The device of claim 1, further comprising:
a second column;
a third column;
the second column and the third column also holding the fluoride tablets;
the water passing into any combination of the column, the second column, and the third column;
whereby the water to the column, the second column, the third column can be turned on or off, thus allowing for refilling the column with fluoride tablets.

7. A device for fluorinating water that allows water flow only if fluoride tablets are fully immersed, the device comprising:
a column;
the column including a top and a base;
a hollow internal space inside the column to hold fluoride tablets;
a water inlet to carry water into the column;
a water outlet to carry water out of the column;
the water outlet higher within the column that the water inlet;
the water outlet connecting to an outlet riser, the outlet riser carrying water out of the column;
an overflow water level;
the overflow water level even with a height of the water outlet, such that when the water rises to the water outlet, it overflows into the water outlet;
whereby water flows through the column from bottom to top, ensuring that water cannot pass through the column unless the column is full of water up to the overflow water level.

8. The device of claim 7, wherein the water only exits the column when the water has risen to an overflow water level that is even with the water outlet at the top of the column.

9. The device of claim 8, further comprising:
an inlet screen at the water inlet, preventing fragments of the fluoride tablets from passing into the water inlet; and
an outlet screen at the water outlet, preventing fragments of the fluoride tablets from passing into the water outlet.

10. The device of claim 7, wherein the fluoride tablets comprise:
sodium fluorosilicate;
a binder; and
a punch release aid.

11. The device of claim 9, further comprising:
an isolation valve upstream of the column;
a flow meter upstream of the column;
a check valve downstream of the column;
whereby the isolation valve is used to start and stop the water from reaching the column from the water inlet, and the check valve prevents water from flowing into the water outlet, thus allowing for refilling of the fluoride tablets; and
whereby the flow meter meters the water, thus allowing for measurement of the water.

12. The device of claim 11, further comprising:
a second column;
a third column;
the second column and the third column also holding the fluoride tablets;
the water passing into any combination of the column, the second column, and the third column;
whereby the flow of water to the column, the second column, the third column can be turned on or off, thus allowing for refilling of the fluoride tablets.

13. A system for consistently fluorinating water regardless of flow rate, the system comprising:
a column with a bottom-mounted inlet and a top-mounted outlet;
the column including a space for a multiplicity of fluoride tablets;
whereby water enters the bottom-mounted inlet, flows up through the column, around the multiplicity of fluoride tablets, and out the top-mounted outlet, thus ensuring that whether the flow rate of water is high or low, the water must reach the top-mounted outlet to leave the column.

14. The system of claim 13, wherein the water only exits the column when the water has risen to an overflow water level that is even with the top-mounted outlet of the column.

15. The system of claim 13, further comprising:
an inlet screen inside the column at a water inlet, preventing fragments of the multiplicity of fluoride tablets from passing into the water inlet; and
an outlet screen inside the column at a water outlet, preventing fragments of the multiplicity of fluoride tablets from passing into the water outlet.

16. The system of claim 13, wherein the multiplicity of fluoride tablets comprise:
sodium fluorosilicate;
a binder; and
a punch release aid.

17. The system of claim 13, further comprising:
an isolation valve upstream of the column;
a flow meter upstream of the column;
a check valve downstream of the column;
whereby the isolation valve is used to start and stop the water from reaching the column from the inlet, and the check valve prevents water from flowing into the outlet, thus allowing for refilling of the multiplicity of fluoride tablets; and
whereby the flow meter meters the water, thus allowing for measurement of the water.

18. The system of claim 13, further comprising:
a second column;
a third column;
the second column and the third column also holding the multiplicity of fluoride tablets;
the water passing into any combination of the column, the second column, and the third column;
whereby the water to the column, the second column, the third column can be turned on or off, thus allowing for refilling of the fluoride tablets.
